(19) United States
(12) Patent Application Publication
(10) Pub. No.: US 2007/0273224 A1
(43) Pub. Date: Nov. 29, 2007

(54) Vibration motor and oilless bearing

(75) Inventor: Sang-Gil An, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO MECHANICS CO., LTD., Suwon (KR)

(21) Appl. No.: 11/802,100

(22) Filed: May 18, 2007

(30) Foreign Application Priority Data
May 18, 2006 (KR) 10-2006-0044828

(51) Int. Cl. H02K 7/06; H02K 5/16

(52) U.S. Cl. 310/81; 310/90

(57) ABSTRACT

An oilless bearing and a vibration motor having the oilless bearing are disclosed. The vibration motor that includes a housing having an internal space, an oilless bearing which is inserted and secured in the housing, and a shaft of which one end is at least partially inserted into the oilless bearing, where the oilless bearing has a contact part which is in contact with the perimeter of the shaft and a non-contact part which is formed adjoining the contact part and which has a diameter greater than the diameter of the shaft, and where the non-contact part is positioned further outward compared to the contact part, can improve the properties of the vibration motor and reduce mechanical noise, while increasing durability.

### CROSS-REFERENCE TO RELATED APPLICATIONS

This application claims the benefit of Korean Patent Application No. 10-2006-0044828 filed with the Korean Intellectual Property Office on May 18, 2006, the disclosure of which is incorporated herein by reference in its entirety.

### BACKGROUND

1. Technical Field

The present invention relates to a vibration motor and an oilless bearing.

2. Description of the Related Art

A vibration motor that uses an eccentric rotor is currently under wide use in mobile terminals, such as mobile phones and PDA's, etc., as a means of as a means of creating vibration upon receipt of incoming calls. As the electronic devices such as mobile terminals, to which the vibration motor is applied, are trending towards smaller sizes and higher performance, so also is the vibration motor being given smaller sizes and higher performance, at which the issue of the durability of the vibration motor is rising in importance.

FIG. 1 is a cross-sectional view illustrating a regular vibration motor according to prior art. Referring to FIG. 1, the conventional vibration motor has a shaft 3 rotatably inserted into a case 1 and bracket 2 by way of an oilless bearing 4, where a rotor 6 having a coil 7 and weight 8 are inserted onto the shaft 3 to rotate together with the shaft 3. Also, there are commutators (not shown) on the lower surface of the rotor 6 that are in contact with brushes 5, and the electric current inputted through the printed circuit board 9 and brushes 5 are delivered through the commutators to the coils 7, to form an electric field.

Also, a magnet 10 positioned on the printed circuit board 9 generates a magnetic field, where the interaction between the electric field generated by the coils 7 and the magnetic field generated by the magnet 10 cause the rotor 6 to rotate. An eccentric weight 8 is positioned on the rotor 6, because of which the rotation of the rotor 6 creates vibration.

An oilless bearing 4 is inserted at each end of the shaft 3, in order to reduce friction between the shaft 3 and the case 1 and between the shaft 3 and the bracket 2, and in order to obtain smooth rotation of the shaft 3. An oilless bearing is formed from a sintered metal material in a porous shape and is used to support various types of motor rotation axles. Inside the oilless bearing, there is an oil containment member that contains the oil, where the rotation of the shaft causes the oil contained in the oil containment member to be drawn out to the exterior and provide lubrication.

FIG. 2a is a cross sectional view illustrating one end of a shaft 3 inserted into an oilless bearing 4. Referring to FIG. 2a, the oilless bearing 4 is inserted and secured in the case 1 and bracket 2, etc., with parts of its inner perimeter touching the shaft 3. Therefore, friction is applied at the interface of the shaft 3 and the oilless bearing 4 due to the rotation of the shaft 3, and this friction, as illustrated in FIG. 2b, creates an abraded part 4a on the inner perimeter of the oilless bearing 4. On the contrary, in parts of the inner perimeter of the oilless bearing 4 that are not in contact with the shaft 3, there is no friction generated, and thus no abrasion (4b of FIG. 2b).

However, in such cases where the orientation of the motor is changed or where the supporting forces of the brushes 6 with respect to the rotor 6 are unstable, or in cases where an external force is applied that can move the rotor in the axial direction, the shaft 3 may rotate while touching the non-abraded part 4b of the oilless bearing 4. In such cases, when the shaft 3 moves across the boundary between the abraded part 4a and the non-abraded part 4b, or when the shaft 3 is operated while supported on the non-abraded part 4b, the changes in load applied to the motor may deteriorate the properties of the motor and may cause mechanical noise. In addition, the shaft 3 being thus supported by the non-abraded part 4b may also act as a factor in decreasing the durability of the oilless bearing 4.

### SUMMARY

An aspect of the invention is to provide an oilless bearing and a vibration motor having the oilless bearing, which improve the properties of the vibration motor and reduce mechanical noise, while increasing durability.

One aspect of the invention provides a vibration motor that includes a housing having an internal space, an oilless bearing which is inserted and secured in the housing, and a shaft of which one end is at least partially inserted into the oilless bearing, where the oilless bearing has a contact part which is in contact with the perimeter of the shaft and a non-contact part which is formed adjoining the contact part and which has a diameter greater than the diameter of the shaft, and where the non-contact part is positioned further outward compared to the contact part.

Embodiments of the vibration motor according to certain aspects of the invention may include one or more of the following features. For example, the housing may include a bracket and a cover coupled with the bracket to form an internal space, where the bracket and the cover each have a boss in which the oilless bearing is inserted, and where the oilless bearing is inserted into each of the bosses. Also, a flange protruding outward may be formed on an end of the oilless bearing, and the bottom surface of the flange may be in contact with an end of the boss. Also, an end of the shaft may be positioned inside the non-contact part, a round 57a may be formed at an end of the shaft, and the round 57a may be in contact with a thrust oilless bearing.

Another aspect of the invention provides an oilless bearing having a through-hole, in the center of which a shaft is inserted, where the through-hole has a contact part which is in contact with the shaft, and a non-contact part which is formed adjoining the contact part and which has a diameter greater than the diameter of the shaft. A flange protruding outward may be formed on an end of the oilless bearing.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view of a conventional vibration motor.

FIG. 2a is a magnified cross-sectional view of portion “A” in FIG. 1.

FIG. 2b is a cross-sectional view illustrating the oilless bearing of FIG. 2a with its inside abraded due to extended periods of rotation of the shaft.

FIG. 3 is a cross-sectional view of a vibration motor according to an embodiment of the invention.

FIG. 4 is a magnified cross-sectional view of portion “B” in FIG. 3.

FIG. 5 is a cross-sectional view of a vibration motor according to another embodiment of the invention.

FIG. 6 is a cross-sectional view of a vibration motor according to yet another embodiment of the invention.

FIG. 7 is a magnified cross-sectional view of portion “C” in FIG. 6.

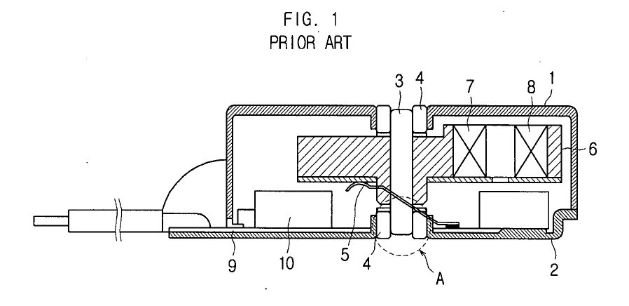

### DETAILED DESCRIPTION

Embodiments of the oilless bearing and the vibration motor having the oilless bearing, according to certain aspects of the invention, will be described below in more detail with reference to the accompanying drawings. In the description with reference to the accompanying drawings, those components are rendered the same reference number that are the same or are in correspondence regardless of the figure number, and redundant explanations are omitted.

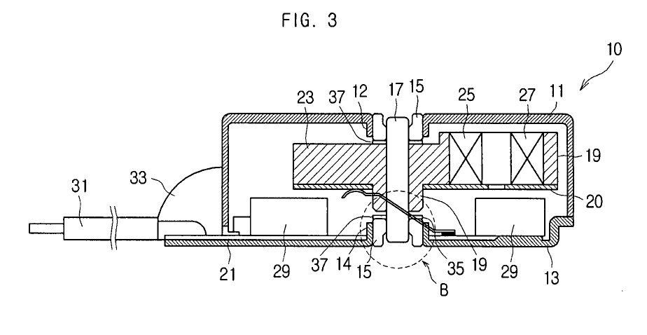

Referring to FIG. 3, a vibration motor 10 according to an embodiment of the invention may have an outer body composed of a case 11 and a bracket 13, and in the centers of the case 11 and the bracket 13 may be formed bosses 12, 14, in which the oilless bearing 15 may be inserted. Also, a rotor 19 for creating vibration may be secured to a predetermined position on the shaft 17 inserted in the case 11 and bracket 13 by way of the oilless bearing 15. Also, a magnet 29 and brushes 35 may be secured to the upper surface of the bracket 13, with the brushes 35 in contact with the lower surface of the rotor 19.

The oilless bearing 15 has a through-hole in which the shaft 17 may be inserted, and its inner perimeter may be composed of a contact part 15a that is in contact with the outer perimeter of the shaft 17 and a non-contact part 15b that is not in contact with the outer perimeter of the shaft 17. Thus, the shaft 17 may always be in contact only with the contact part 15a, and even when the shaft 17 is moved vertically due to an external impact or a change in supporting forces of the brushes 35, its perimeter may always be in contact with all of the contact part 15a.

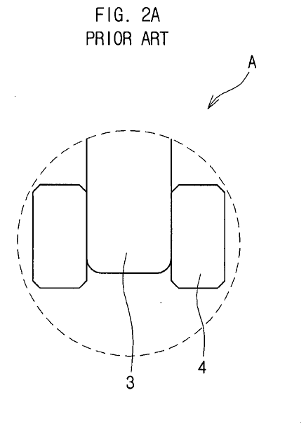

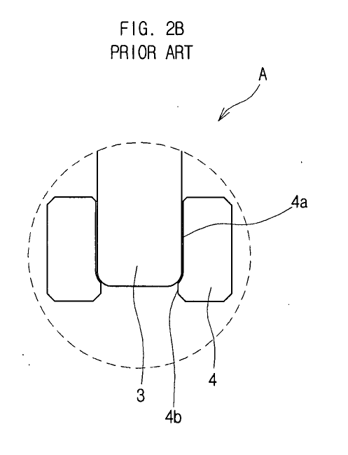

Therefore, since there are no level differences between the abraded part 4a and non-abraded part 4b, such as that illustrated in FIG. 2b, in the oilless bearing 15 of a vibration motor 10 according to this embodiment, the vibration properties of the motor may be improved, such as durability, endurance, and vibration and noise characteristics.

The bracket 13 may have the shape of a circular plate, with the magnet 29, brushes 35, and printed circuit board 21 positioned on it. Also, an upwardly-protruding boss 14 may be formed in the center of the bracket 13, where the oilless bearing 15 may be inserted and secured inside the boss 14. The case 11 may have the same circular cross section and may be coupled with the bracket 13 to form a certain internal space. In the center of the case 11 may be a downwardly-protruding boss 12 that is in correspondence with the boss 14 of the bracket 13, inside which the oilless bearing 15 may be inserted and secured.

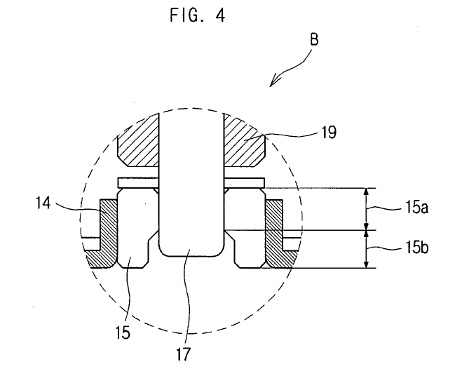

The oilless bearing 15 may be pressed into and secured in each boss 12, 14, and the shaft 17 may be inserted inside the oilless bearing 15. The oilless bearing 15 allows smooth rotating of the shaft 17 while in contact with the perimeter of the shaft 17. As illustrated in FIG. 4, in the inner perimeter of the oilless bearing 15, there may be formed a contact part 15a, which is in contact with the outer perimeter of the shaft 17, and a non-contact part 15b, which has an increased diameter from that of the contact part 15a and which is not in contact with the perimeter of the shaft 17.

As illustrated in FIG. 4, the contact part 15a may always be in contact with the perimeter of the shaft 17. Thus, when the shaft 17 rotates, the oil (not shown) contained in the inner perimeter of the contact part 15a is drawn out, to form a film of oil between the inner perimeter of the contact part 15a and the outer perimeter of the shaft 17 and allow smooth rotating of the shaft 17. Abrasion may occur at the interface between the contact part 15a and the shaft 17 due to friction, where such friction would be formed over the entire inner perimeter of the contact part 15a. Thus, even when the shaft 17 is moved vertically due to an external impact or a change in supporting forces of the brushes 35, it may always be in contact with the contact part 15a.

The non-contact part 15b is the part formed adjoining the contact part 15a on the inside of the oilless bearing 15, and may have an increased diameter compared to that of the contact part 15a, i.e. a diameter somewhat larger than that of the shaft 17. Thus, the non-contact part 15b may not be in contact with the outer perimeter of the shaft 17. Also, since the non-contact part 15b faces the end of the shaft 17, i.e. the outside of the case 11 or bracket 13, compared to the contact part 15a, as illustrated in FIG. 3, the shaft 17 may always be in contact with only the contact part 15a.

The shaft 17 may have each end inserted in an oilless bearing 15 and may rotate together with the rotor 19. The shaft 17 may generally be fabricated from a strong material such as steel, etc. The diameter of the shaft 17 may be substantially equal to the diameter of the contact part 15a of the oilless bearing 15. Also, at one end of the shaft 17, a portion may be in contact with the contact part 15a while the remaining portions may not be in contact with the non-contact part 15b while inserted inside the non-contact part 15b. Thus, the shaft 17 may always maintain contact with the contact part 15a even when there is an external impact, etc., and there are no level differences created, such as that in FIG. 2b, inside the oilless bearing.

The rotor 19 may have coils 25 and a weight 27 secured by a rotor mold 23 on a base material 20, with commutators (not shown) formed on the lower surface of the base material 20 that are in electrical contact with the brushes 35. The rotor 19 may be inserted and secured onto a predetermined position on the shaft 17. An electrical current inputted through the commutators that are in contact with the brushes 35 may be delivered to the coils 25, whereby an electrical field may be formed around the coils 25. Since the weight 27 may be positioned eccentrically with respect to the center of rotation of the rotor 19, the rotation of the rotor 19 may create a certain amount of vibration. A washer 37 may be inserted between the upper and/or lower surface of the rotor 19 and the oilless bearing 15, to prevent the rotor 19 from moving vertically with respect to the shaft 17.

A printed circuit board 21 may be positioned on the upper surface of the bracket 13, where the brushes 35 may be electrically coupled to the printed circuit board 21. The brushes 35 may elastically support the lower surface of the rotor 19, while at the same time maintaining contact with the commutators. Also, the magnet 29 may be positioned on the printed circuit board 21. The magnet 29 may be positioned to face the coils 25 of the rotor 19, and electromagnetic forces may be created by the interaction between the magnetic field generated by the magnet 29 and the electric field generated by the coils 25. The printed circuit board 21 may be electrically connected by means of lead wires 31 with an external device, and reinforcing bond 33 may be formed at the interfaces between the printed circuit board 21 and the lead wires 31 in order to prevent the lead wires 31 from becoming detached and to prevent the infiltration of dust or moisture, etc.

With reference to FIGS. 3 and 4, a description will now be given on the operation of the vibration motor 10 according to an embodiment of the invention.

An electric current is supplied through the lead wires 31 and printed circuit board 21 to the brushes 35, where the brushes 35 are in electrical contact with the commutators (not shown) formed on the lower surface of the rotor 19. Thus, due to the rotation of the rotor 19, the brushes 35 sequentially come into contact with the commutators, so that the electric current is delivered to the commutators, and since the commutators are connected with the coils 25, the electric current is delivered to the coils 25. In this way, an electric field is formed around the coils 25.

Since the coils 25 are positioned facing the magnet 29, the electric field formed around the coil 25 interacts with the magnetic field formed around the magnet 29 to create electromagnetic forces that drive the rotor 19. Since the rotor 19 has a weight 27 that is positioned eccentrically with respect to the shaft 17, which serves as the center of rotation, a certain vibration is created by the rotation of the rotor 19, and the vibration thus generated is transferred through the shaft 17 to the case 11 and bracket 13.

The rotor 19 may have a mass relatively larger than other components, because of the coils 25 and weight 27, etc., positioned on it. Therefore, when an external impact is applied, such as by dropping the vibration motor 10, etc., the rotor 19 and the shaft 17 secured to the rotor 19 to rotate as a single body may be moved vertically. However, since the oilless bearing 15 of the vibration motor 10 according to this embodiment may have the non-contact part 15b formed in the direction in which the shaft 17 can move, there may be no mechanical noise or vibration created as in the vibration motor 10 illustrated in FIGS. 2a and 2b, and the shaft 17 may always be in contact with the contact part 15a.

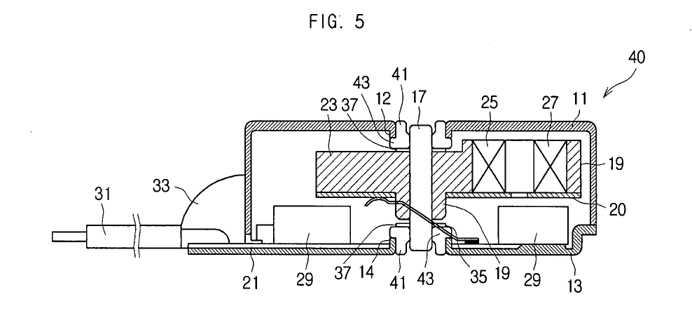

A description will now be given on a vibration motor 40 according to another embodiment of the invention, with reference to FIG. 5. The components other than the oilless bearing 41 in the vibration motor 40 according to another embodiment of the invention are the same as those for the vibration motor 10 described with reference to FIGS. 3 and 4. Thus, the description of the vibration motor 40 according to another embodiment of the invention will focus on the oilless bearing 41.

The oilless bearings 41 may have the shaft 17 inserted therein for smooth rotating of the shaft 17, with contact parts 41a in contact with the perimeter of the shaft 17 and non-contact parts 41b formed adjoining the contact parts 41a, which have an increased diameter and which are not in contact with the shaft 17. Also, at an end of an oilless bearing 41, there may be formed an outwardly protruding flange 43. The flange 43 contact the end of the boss 12, 14 of the case 11 or bracket 13, to allow the oilless bearing 41 to be firmly pressed into the boss 12, 14. Thus, the oilless bearing 41 is prevented from becoming detached, and the resulting vibration of the shaft 17 may be avoided as well.

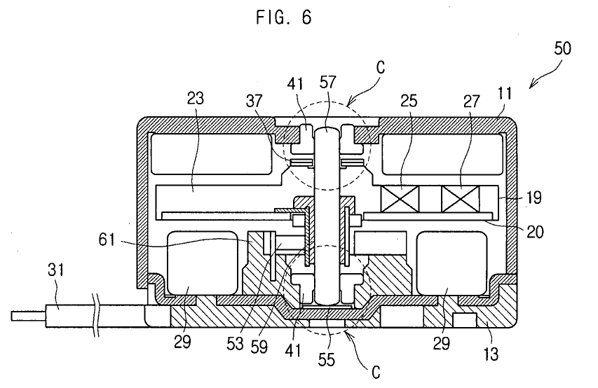

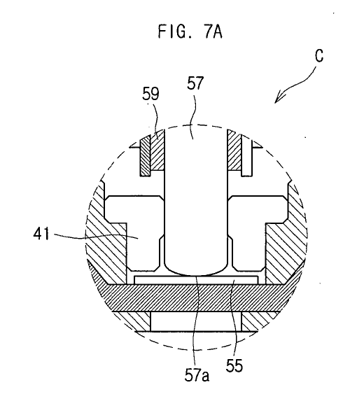

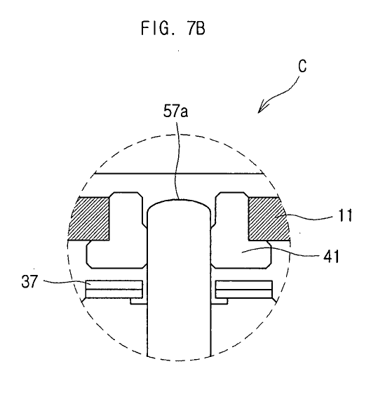

A description will now be given on a vibration motor 50 according to yet another embodiment of the invention, with reference to FIG. 6. The components other than the shaft 57, commutators 59, and brushes 53 in the vibration motor 50 according to another embodiment of the invention are the same as those for the vibration motor 40 described with reference to FIG. 5. Thus, the description below will focus on the shaft 57, brushes 53, and commutators 59.

The brushes 53 according to an embodiment of the invention may be secured to the base mold 61 and may be arranged to face inward of the shaft 57. Also, commutators 59 may be arranged around the shaft 57 on the perimeter of the shaft 57, with the brushes 53 in elastic contact in a normal direction with respect to the commutators 59. One or both ends of the shaft 57 may be rounded, and one end may be in contact with a thrust washer 55. Thus, smooth rotation is provided for the shaft 57 due to the thrust washer 55 and the round formed on the end.

Also, in a vibration motor 50 according to this embodiment, the magnet 29 may be attached not only on the upper surface of the bracket 13 but also on the inside of the case 11. Thus, as the magnitude of the magnetic field generated by the magnet 29 may be amplified, the amount of vibration of the rotor 19 may be increased.

According to certain aspects of the invention as set forth above, an oilless bearing and a vibration motor having the oilless bearing can be provided, which improve the properties of the vibration motor and reduce mechanical noise, while increasing durability.

While the present invention has been described with reference to particular embodiments, it is to be appreciated that various changes and modifications may be made by those skilled in the art without departing from the spirit and scope of the present invention, as defined by the appended claims and their equivalents.

What is claimed is:

1. A vibration motor comprising:
a housing having an internal space;
an oilless bearing inserted and secured in the housing; and
a shaft having one end at least partially inserted into the oilless bearing,
the oilless bearing having a contact part configured to be in contact with the perimeter of the shaft and a non-contact part formed adjoining the contact part and having a diameter greater than the diameter of the shaft, and
the non-contact part positioned further outward compared to the contact part.

2. The vibration motor of claim 1, wherein the housing comprises a bracket and a cover coupled with the bracket to form an internal space, the bracket and the cover each having a boss in which the oilless bearing is inserted, and
the oilless bearing configured to be inserted in each of the bosses.

3. The vibration motor of claim 2, wherein a flange protruding outward is formed on an end of the oilless bearing, and
the bottom surface of the flange is in contact with an end of the boss.

4. The vibration motor of claim 1, wherein an end of the shaft is inside the non-contact part.

5. The vibration motor of claim 1, wherein a round is formed at an end of the shaft,
the round configured to be in contact with a thrust oilless bearing.

6. An oilless bearing, having a through-hole in the center of which a shaft is inserted,
the through-hole having a contact part configured to be in contact with the shaft; and
a non-contact part formed adjoining the contact part and having a diameter greater than the diameter of the shaft.

7. The oilless bearing of claim 6, wherein a flange protruding outward is formed on an end of the oilless bearing.
